(19) United States
(12) Patent Application Publication
(10) Pub. No.: US 2023/0126961 A1
(43) Pub. Date: Apr. 27, 2023

(54) Systems And Methods For Securing Input/Output Data

(71) Applicant: Intel Corporation, Santa Clara, CA (US)

(72) Inventors: Han Hua Leong, Penang (MY); Chang Kian Tan, Penang (MY); Ven Ci Kok, Penang (MY); Saravanan Sethuraman, Hillsboro, OR (US); Wai Lim Kong, Austin, TX (US)

(73) Assignee: Intel Corporation, Santa Clara, CA (US)

(21) Appl. No.: 18/089,398

(22) Filed: Dec. 27, 2022

(51) Int. Cl. G06F 21/60; G06F 21/76

(52) U.S. Cl. CPC G06F 21/602; G06F 21/76; G06F 2221/0755

(57) ABSTRACT

Methods and systems are provided for decrypting and/or encryption information received by and/or transmitted from an integrated circuit (IC) device input/output (I/O) interface. A decryption circuit is configurable to apply a first decryption algorithm selected from a plurality of decryption algorithms to received information. An encryption circuit is configurable to apply a first encryption algorithm selected from a plurality of encryption algorithms to transmitted information. A key wrapping circuit is configurable to wrap decryption and/or encryption keys associated with the first decryption and/or encryption algorithm. A firewall circuit is configurable to prevent unauthorized access to the wrapped decryption and/or encryption keys. The decryption and/or encryption circuits are reconfigurable to apply a second decryption algorithm and/or a second encryption algorithm to the received information and/or the transmitted information.

### FIELD OF THE DISCLOSURE

The present disclosure relates to electronic integrated circuit (IC) systems and methods, and more particularly, to systems and methods for securing input/output (I/O) data.

### BACKGROUND

Integrated circuit (IC) devices such as field-programmable gate array (FPGA) devices utilize input/output (I/O) interfaces to receive and/or send information from and/or to external devices. Such information is often received and/or sent in an unencrypted form and is thus vulnerable to a variety of attacks that aim to intercept and/or alter the information. While a few IC devices apply encryption and/or decryption algorithms to information received and/or sent through the I/O interface, IC devices are typically proprietary and non-configurable. This makes it difficult for programmers, designers, and/or users of IC devices to ensure that the IC devices utilize preferred encryption and/or decryption algorithms.

### BRIEF DESCRIPTION OF THE DRAWINGS

FIG. 1 illustrates an example of an integrated circuit (IC) device that applies configurable encryption and/or decryption algorithms to information received and/or sent by the input/output (I/O) interface of the IC device, according to an embodiment.

FIG. 2 illustrates an example of a circuit system that includes two of the integrated circuit (IC) devices shown in FIG. 1, according to an embodiment.

FIG. 3 illustrates an example of a programmable IC that can implement techniques disclosed herein, according to an embodiment.

FIG. 4 is a diagram showing how configuration data is created by a logic design system and loaded into a programmable logic integrated circuit (IC) to configure the IC for operation in a system in accordance with an embodiment.

FIG. 5 is a diagram of a circuit design system that can be used to design integrated circuits in accordance with an embodiment.

FIG. 6 is a diagram of illustrative computer-aided design (CAD) tools that can be used in a circuit design system in accordance with an embodiment.

### DETAILED DESCRIPTION

As used herein, the term “or” shall convey both disjunctive and conjunctive meanings. For instance, the phrase “A or B” shall be interpreted to mean the element A alone, the element B alone, and the combination of elements A and B.

As discussed above, information received and/or sent by an input/output (I/O) interface of an integrated circuit (IC) device is often unencrypted and is thus vulnerable to interception and/or alteration. Moreover, the proprietary and non-configurable nature of the few IC device that do utilize encryption and/or decryption makes it difficult for programmers, designers, and/or users of IC devices to ensure that the IC devices utilize preferred encryption and/or decryption algorithms. Hence, there is a need for systems and methods that apply configurable decryption and/or encryption algorithms to information received and/or sent by the I/O interface of an IC device.

According to some embodiments disclosed herein, systems and methods are provided for applying configurable decryption and/or encryption algorithms to information received and/or sent by the I/O interface of an IC device. These systems and methods generally utilize a configurable decryption circuit to apply a decryption algorithm to a first bitstream received from outside of the IC device and a configurable encryption circuit to apply an encryption algorithm to a second bitstream transmitted outside of the IC device. In this manner, the first bitstream and the second bitstream are secured against interception and/or alteration by attackers. The decryption algorithm and/or the encryption algorithm may be selected by a programmer, designer, and/or user of the IC device. The IC device may comprise a programmable logic device (PLD), field-programmable gate array (FPGA) device, application specific integrated circuit (ASIC) device, random access memory (RAM) device, or graphics processing unit (GPU) device. The IC device may be used for a variety of purposes, including big data applications, artificial intelligence (AI) applications, machine learning (ML) applications, emulation or prototyping applications, telemetry applications, dynamic load balancing (DLB) applications, multi-FPGA applications, or the like.

The decryption algorithm and/or the encryption algorithm may be associated with a decryption key and/or an encryption key, respectively. The decryption key and/or the encryption key may be wrapped using a key wrapping encryption algorithm applied by a key wrapping circuit of the IC device. The key wrapping encryption algorithm may utilize a wrapping encryption key to wrap the decryption key and/or the encryption key. Such key wrapping may provide further protection to the first bitstream and/or the second bitstream by securing the decryption key and/or the encryption key from interception and/or alteration by an attacker.

The wrapping encryption key may be generated using an entropy source circuit. The entropy source circuit may generate the wrapping encryption key using information provided by the programmer, designer, or user of the IC device or information unique to the IC device itself.

The key wrapping circuit may output a wrapped decryption key and/or a wrapped encryption key. The wrapped decryption key and/or the wrapped encryption key may be protected from unauthorized access using a firewall circuit. Such a firewall circuit may provide even further protection to the first bitstream and/or the second bitstream by securing the wrapped decryption key and/or the wrapped encryption key from interception and/or alteration by an attacker.

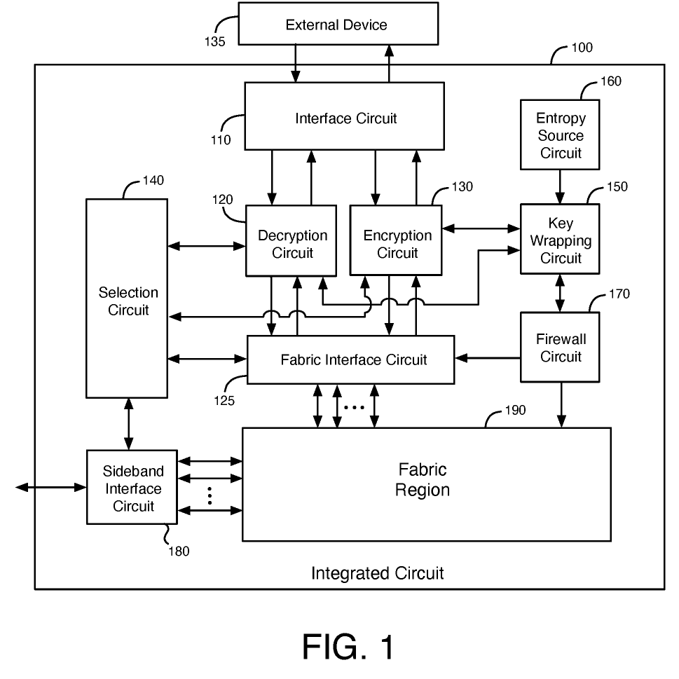

FIG. 1 illustrates an example of an integrated circuit (IC) device 100 that applies configurable encryption and/or decryption algorithms to information received and/or sent by the interface of the IC device, according to an embodiment. The IC device 100 may be, for example, a PLD, FPGA device, ASIC device, RAM device, or GPU device. Alternatively, the IC device 100 may be, for example, a configurable block of a larger device, such as a configurable block of a PLD, FPGA device, ASIC device, RAM device, or GPU device. The IC device 100 may be used for a variety of purposes, including big data applications, AI applications, ML applications, emulation or prototyping applications, telemetry applications, DLB applications, multi-FPGA applications, or the like.

The IC device 100 includes an interface circuit 110. The interface circuit 110 receives data (e.g., a first bitstream or an input bitstream) from outside of the IC device 100 (e.g., from external device 135). The interface circuit 110 transmits data (e.g., a second bitstream or an output bitstream) outside of the IC device (e.g., to external device 135). The interface circuit 110 may be, for example, an input/output (I/O) interface. The interface circuit 110 may be, for instance, a digital I/O interface, serial I/O interface, parallel I/O interface, high speed I/O (HSIO) interface, external memory interface (EMIF), high speed serial interface (HSSI), general purpose I/O (GPIO) interface, peripheral component interconnect (PCI) interface, universal serial bus (USB) interface, plug-n-play (PnP) interface, small computer system interface (SCSI), mobile industry processor interface (MIPI), serial peripheral interface (SPI), quad SPI (QSPI), inter-integrated circuit (I2C) interface, controller area network (CAN) interface, joint test action group (JTAG) interface, hard processor system (HPS) interface, or the like.

The IC device 100 includes a decryption circuit 120. The decryption circuit 120 is configurable to apply a first decryption algorithm to the first bitstream to thereby decrypt the first bitstream to generate a decrypted first bitstream. The first decryption algorithm can be selected from a plurality of decryption algorithms in response to control signals received from selection circuit 140, as described in further detail below. Applying the first decryption algorithm to the first bitstream allows the decryption circuit 120 to decrypt and utilize the first bitstream received at the interface 110 to generate the decrypted first bitstream. The first decryption algorithm may be based on a cryptographic standard, such as the advanced encryption standard (AES), AES-128, AES-192, AES-256, AES-counter (AES-CTR), AES-cipher block chaining (AES-CBC), AES-Galois counter mode (AES-GCM), pretty good privacy (PGP), or OpenPGP cryptographic standard. The decryption algorithm may be selected from a cryptographic library, such as Rust’s sha3, Botan, Bouncy Castle, cryptlib, Crypto, Crypto++, Libgcrypt, Nettle, OpenSSL, wolfSSL, wolfCrypt, GnuTLS, mbed TLS, LibreSSL, MIRACL Cryptographic SDK, libkeccak, libgcrypt, or Crypto API. Alternatively, the decryption algorithm may be provided or generated by a programmer, designer, or user of the IC device 100.

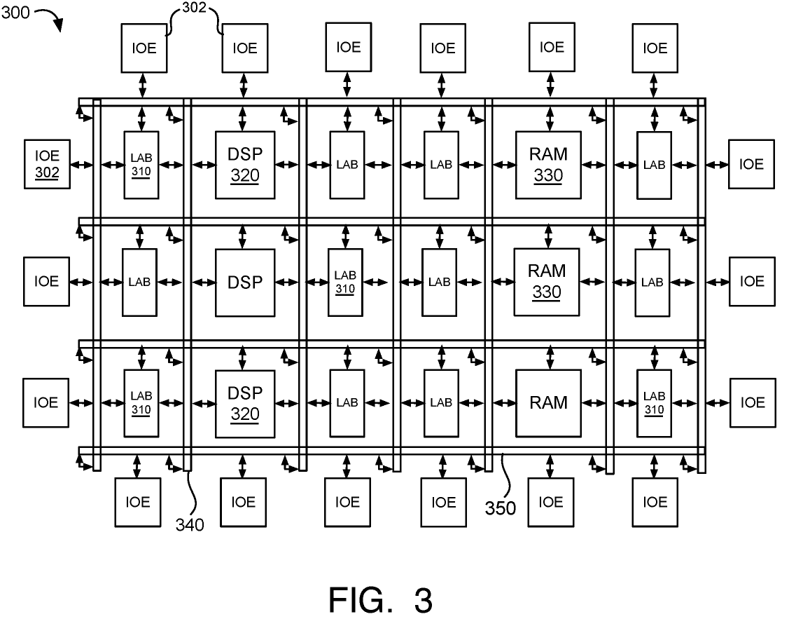

The IC device 100 also includes a fabric interface circuit 125 and a fabric region 190. Fabric region 190 includes configurable functional circuit blocks, as disclosed herein, for example, with respect to FIG. 3. The configurable functional circuit blocks in the fabric region 190 can be configured to perform functions for a variety of applications, such as big data and/or AI inference, emulation/prototyping of designs for integrated circuits, multi-FPGA expansion, telemetry, a central processing unit or system-on-chip, post-processing, and dynamic load balancing.

The fabric interface circuit 125 provides the decrypted first bitstream generated by the decryption circuit 120 to configurable functional circuit blocks in the fabric region 190 through one or more busses or programmable routing channels. The fabric interface circuit 125 can provide authentication for the decrypted first bitstream using, for example, an authentication algorithm or protocol according to any security standard. The authentication algorithm can be, for example, one or more of the Rivest-Shamir-Adleman (RSA), RSA-1024, RSA-2048, RSA-3072, RSA-4096, RSA-7680, RSA-9192 digital signature algorithm (DSA), elliptic curve DSA (ECDSA), ECDSA-128, ECDSA-256, ECDSA-384, Brainpool, Brainpool-256, Brainpool-384, Brainpool-512, secure hash algorithm (SHA), SHA2, SHA2-224, SHA2-256, SHA2-384, SHA2-512, SHA2-512/224, SHA2-512/256, SHA3, SHA3-256, SHA3-384, SHA3-512, Keccak, SHA and Keccak (SHAKE), SHAKE-128, or SHAKE256 algorithms. The fabric region 190 can then use the decrypted first bitstream for processing functions according to an application or to configure the configurable functional circuit blocks.

The IC device 100 includes an encryption circuit 130. The encryption circuit 130 is configurable to apply a first encryption algorithm to the second bitstream to thereby encrypt the second bitstream as an encrypted second bitstream. The first encryption algorithm may be selected from a plurality of encryption algorithms in response to control signals received from selection circuit 140, as described in further detail below. Applying the first encryption algorithm to the second bitstream allows the encryption circuit 130 to encrypt the second bitstream as the encrypted second bitstream that the interface 110 transmits outside the IC device 100 (e.g., to external device 135). The encryption algorithm may be based on a cryptographic standard, such as the AES, AES-128, AES-192, AES-256, AES-CTR, AES-CBC, AES-GCM, PGP, or OpenPGP cryptographic standard. The encryption algorithm may be selected from a cryptographic library, such as Rust’s sha3, Botan, Bouncy Castle, cryptlib, Crypto, Crypto++, Libgcrypt, Nettle, OpenSSL, wolfSSL, wolfCrypt, GnuTLS, mbed TLS, LibreSSL, MIRACL Cryptographic SDK, libkeccak, libgcrypt, or Crypto API. Alternatively, the encryption algorithm may be provided or generated by a programmer, designer, or user of the IC device 100.

The fabric interface circuit 125 provides the second bitstream from configurable functional circuit blocks in the fabric region 190 to the encryption circuit 130 through one or more busses or programmable routing channels. The fabric interface circuit 125 can provide authentication for the second bitstream using, for example, an authentication algorithm or protocol according to any security standard. The authentication algorithm can be, for example, one or more of the RSA, RSA-1024, RSA-2048, RSA-3072, RSA-4096, RSA-7680, RSA-9192 DSA, ECDSA, ECDSA-128, ECDSA-256, ECDSA-384, Brainpool, Brainpool-256, Brainpool-384, Brainpool-512, SHA, SHA2, SHA2-224, SHA2-256, SHA2-384, SHA2-512, SHA2-512/224, SHA2-512/256, SHA3, SHA3-256, SHA3-384, SHA3-512, Keccak, SHAKE, SHAKE-128, or SHAKE256 algorithms. The encryption circuit 130 encrypts the second bitstream received from the fabric interface circuit 125 to generate the encrypted second bitstream. The interface circuit 110 transmits the encrypted second bitstream outside IC 100.

In the example shown, the IC device 100 comprises a selection circuit 140 (e.g., a control and status register (CSR) circuit). The selection 140 can be configurable to receive a selection of the first decryption algorithm and configure the decryption circuit 120 using control signals to apply the first decryption algorithm to decrypt the first bitstream. The first decryption algorithm may be selected from a plurality of selectable decryption algorithms (e.g., from the list of decryption algorithms described above) by a programmer, designer, or user of the IC device 100. In this manner, the programmer, designer, or user of the IC device 100 may exercise control over the decryption algorithm that is applied to the first bitstream. The ability to select the decryption algorithm may allow the programmer, designer, or user of the IC device to choose how best to balance trade-offs in the decryption algorithm, such as security and speed.

The selection circuit 140 may be configurable to receive a selection of the first encryption algorithm and configure the encryption circuit 130 using control signals to apply the first encryption algorithm to encrypt the second bitstream. The first encryption algorithm may be selected from a plurality of selectable encryption algorithms (e.g., from the list of encryption algorithms described above) by a programmer, designer, or user of the IC device 100. In this manner, the programmer, designer, or user of the IC device 100 may exercise control over the encryption algorithm that is applied to the second bitstream. The ability to select the encryption algorithm may allow the programmer, designer, or user of the IC device to choose how best to balance trade-offs in the encryption algorithm, such as security and speed.

The selection circuit 140 may be configurable to receive the selection of the first decryption algorithm only. Alternatively, the selection circuit 140 may be configurable to receive the selection of the first encryption algorithm only. Alternatively, the selection circuit 140 may be configurable to receive both the selection of the first decryption algorithm and the selection of the first encryption algorithm.

The selection circuit 140 may be further configurable to receive a selection of a second decryption algorithm. The second decryption algorithm may comprise any decryption algorithm described herein. The second decryption algorithm may be different from the first decryption algorithm. The selection circuit 140 may be configurable to reconfigure the decryption circuit 120 to apply the second decryption algorithm to decrypt the first bitstream to generate a decrypted first bitstream. In this manner, the selection circuit 140 may allow a programmer, designer, or user of the IC device 100 to alter the decryption algorithm applied to the first bitstream.

The selection circuit 140 may be further configurable to receive a selection of a second encryption algorithm. The second encryption algorithm may comprise any encryption algorithm described herein. The second encryption algorithm may be different from the first encryption algorithm. The selection circuit 140 may be configurable to reconfigure the encryption circuit 130 to apply the second encryption algorithm to encrypt the second bitstream to generate an encrypted second bitstream. In this manner, the selection circuit 140 may allow a programmer, designer, or user of the IC device 100 to alter the encryption algorithm applied to the second bitstream.

In the example shown, the IC device 100 comprises a key wrapping circuit 150. The key wrapping circuit 150 may be configured to receive a decryption key associated with the first or second decryption algorithm, apply a first key wrapping encryption algorithm to the decryption key, and thereby generate a wrapped decryption key. The first key wrapping encryption algorithm may be based on a cryptographic standard, such as the AES, AES-128, AES-192, AES-256, AES-CTR, AES-CBC, AES-GCM, PGP, or OpenPGP cryptographic standard. The first key wrapping encryption algorithm may be selected from a cryptographic library, such as Rust’s sha3, Botan, Bouncy Castle, cryptlib, Crypto, Crypto++, Libgcrypt, Nettle, OpenSSL, wolfSSL, wolfCrypt, GnuTLS, mbed TLS, LibreSSL, MIRACL Cryptographic SDK, libkeccak, libgcrypt, or Crypto API. Alternatively, the first key wrapping encryption algorithm may be provided or generated by a programmer, designer, or user of the IC device 100.

The key wrapping circuit 150 may be configured to receive an encryption key associated with the first or second encryption algorithm, apply a second key wrapping encryption algorithm to the encryption key, and thereby generate a wrapped encryption key. The second key wrapping encryption algorithm may be based on a cryptographic standard, such as the AES, AES-128, AES-192, AES-256, AES-CTR, AES-CBC, AES-GCM, PGP, or OpenPGP cryptographic standard. The second key wrapping encryption algorithm may be selected from a cryptographic library, such as Rust’s sha3, Botan, Bouncy Castle, cryptlib, Crypto, Crypto++, Libgcrypt, Nettle, OpenSSL, wolfSSL, wolfCrypt, GnuTLS, mbed TLS, LibreSSL, MIRACL Cryptographic SDK, libkeccak, libgcrypt, or Crypto API. Alternatively, the second key wrapping encryption algorithm may be provided or generated by a programmer, designer, or user of the IC device 100.

The key wrapping circuit 150 may be configurable to generate a wrapped decryption key only. Alternatively, the key wrapping circuit 150 may be configured to generate a wrapped encryption only. Alternatively, the key wrapping circuit 150 may be configured to generate both a wrapped decryption key and a wrapped encryption key.

The key wrapping circuit 150 may be configured to store the wrapped decryption key and/or the wrapped encryption key in one or more memory elements that can be locked. The one or more memory elements can store the wrapped decryption key and/or the wrapped encryption key in a look-up table (LUT). When the wrapped decryption key and/or the wrapped encryption key are changed (e.g., by a programmer, designer, or user of the IC device 100 providing a new decryption key and/or a new encryption key), the one or more memory elements may be reconfigured. The one or more memory elements may be reconfigured by changing the one or more memory elements from LUT mode into RAM mode, modifying the contents of the one or more memory elements, changing the one or more memory elements from RAM mode to LUT mode, and blocking user access to the one or more memory elements. The key wrapping circuit 150 can unwrap the wrapped decryption key and/or the wrapped encryption key and provide the unwrapped decryption key and/or the unwrapped encryption key to the decryption circuit 120 and/or the encryption circuit 130, respectively.

In the example shown, the IC device 100 comprises an entropy source circuit 160. The entropy source circuit 160 is configurable to generate a wrapping encryption key associated with the key wrapping encryption algorithm. The entropy source circuit 160 may generate the wrapping encryption key using information provided by the programmer, designer, or user of the IC device 100. For instance, the entropy source circuit 160 may generate the wrapping encryption key using a string of digits provided by the programmer, designer, or user of the IC device 100. Alternatively, the entropy source circuit 160 may generate the wrapping encryption key using information unique to the IC device 100 itself. For instance, the entropy source circuit 160 may generate the wrapping encryption key using a string of digits associated with a state of one or more components of the IC device 100 or the IC device 100 itself, such as a unique identification (ID) number or unit level traceability (ULT) token associated with the IC device 100 or one or more components of the IC device 100, a clock state of the IC device 100 or one or more components of the IC device 100, a physically unclonable function, or the like.

In the example shown, the IC device 100 comprise a firewall circuit 170. The firewall circuit 170 may be configured to prevent unauthorized access to the wrapped decryption key. The firewall circuit 170 may be configured to prevent unauthorized access to the wrapped encryption key. The firewall circuit 170 may be configured to prevent unauthorized access to both the wrapped decryption key and the wrapped encryption key. In this manner, the firewall circuit 170 provides an extra layer of protection to prevent attacks involving access to the wrapped decryption key and/or the wrapped encryption key, such as signal tap attacks or JTAG-AVMM attacks. Should a programmer, designer, or user of the IC device 100 need debugging access, the firewall circuit 170 may be configured to allow access using a debug token.

In the example shown, the IC device 100 comprises a sideband interface 180. The sideband interface circuit 180 can be configured to provide control signals to the selection circuit 140. The selection circuit 140 can use the control signals received from the sideband interface circuit 180 to select the decryption/encryption algorithms used by the decryption and encryption circuits 120 and 130, respectively (e.g., the first decryption algorithm, the first encryption algorithm, the second decryption algorithm, and/or the second encryption algorithm). The sideband interface circuit 180 can receive control information from a source external to IC 100. The sideband interface circuit 180 can use this control information to generate the values of the control signals that are used for the selection of the encryption/decryption algorithms by the selection circuit 140. The sideband interface circuit 180 can communicate with the external source using any suitable protocol or interface standard, such as a digital I/O, serial I/O, parallel I/O, HSIO, EMIF, HSSI, GPIO, PCI, USB, PnP, SCSI, MIPI, SPI, QSPI, I2C, CAN, JTAG, HPS, or the like.

The configurable functional circuit blocks in the fabric region 190 can provide control information to the sideband interface circuit 180 through one or more busses or programmable routing channels, while the configurable functional circuit blocks are executing one or more applications. The sideband circuit 180 can use this control information received from the fabric region 190 to generate the values of the control signals that are used for the selection of the encryption/decryption algorithms by the selection circuit 140.

Further disclosed herein is a graphical user interface (GUI) for configuring the IC device of FIG. 1. The GUI may include user-selectable fields (such as drop-down lists) for supplying programmer, designer, or user selections. Such selections may include the I/O interface type and IC device fabric interface type. The programmer, designer or user may also select the authentication key for the key wrapping encryption algorithm, the size of the encryption and/or decryption keys, the first and/or second decryption and/or encryption algorithm, and the decryption and/or encryption keys to configure the decryption and/or encryption circuits described herein with respect to FIG. 1. The programmer, designer, or user may also select the entropy source to configure the entropy source circuit 160 described herein with respect to FIG. 1. The GUI may pass any or all of this information to a non-transitory computer-readable medium that is configured to implement functions described herein with respect to FIG. 1.

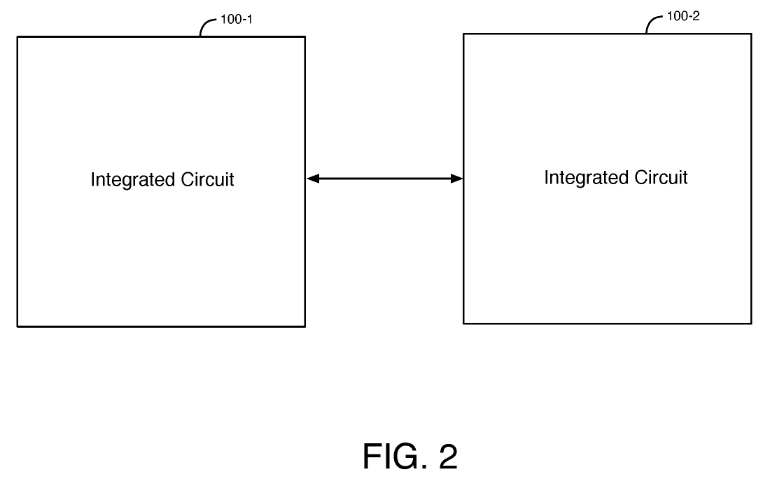

FIG. 2 illustrates an example of a circuit system that includes two of the IC devices 100 shown in FIG. 1. In the example of FIG. 2, each of first and second IC devices 100-1 and 100-2 includes the circuity that is shown in FIG. 1 herein. The IC device 100-1 is configurable to transmit encrypted bitstreams to and receive encrypted bitstreams from IC device 100-2. The IC device 100-2 is configurable to transmit encrypted bitstreams to and receive encrypted bitstreams from IC device 100-1. Each of the IC devices 100-1 and 100-2 is configurable to encrypt and decrypt the bitstreams as disclosed herein with respect to FIG. 1.

FIG. 3 illustrates an example of a programmable logic IC 300 that can implement techniques disclosed herein. As shown in FIG. 3, the programmable logic IC 300 includes a two-dimensional array of configurable functional circuit blocks (e.g., in fabric region 190), including configurable logic array blocks (LABs) 310 and other functional circuit blocks, such as random access memory (RAM) blocks 330 and digital signal processing (DSP) blocks 320. Functional blocks such as LABs 310 can include smaller programmable logic circuits (e.g., logic elements, logic blocks, or adaptive logic modules) that receive input signals and perform custom functions on the input signals to produce output signals.

In addition, programmable logic IC 300 can have input/output elements (IOEs) 302 for driving signals off of programmable logic IC 300 and for receiving signals from other devices. IOEs 302 may include parallel input/output circuitry, serial data transceiver circuitry, differential receiver and transmitter circuitry, or other circuitry used to connect one integrated circuit to another integrated circuit. As shown, IOEs 302 may be located around the periphery of the chip. If desired, the programmable logic IC 300 may have IOEs 302 arranged in different ways. For example, IOEs 302 may form one or more columns, rows, or islands of input/output elements that may be located anywhere on the programmable IC 300.

The programmable logic IC 300 can also include programmable interconnect circuitry in the form of vertical routing channels 340 (i.e., interconnects formed along a vertical axis of programmable logic IC 300) and horizontal routing channels 350 (i.e., interconnects formed along a horizontal axis of programmable logic IC 300), each routing channel including at least one track to route at least one wire.

Note that other routing topologies, besides the topology of the interconnect circuitry depicted in FIG. 3, may be used. For example, the routing topology may include wires that travel diagonally or that travel horizontally and vertically along different parts of their extent as well as wires that are perpendicular to the device plane in the case of three dimensional integrated circuits. The driver of a wire may be located at a different point than one end of a wire.

Furthermore, it should be understood that embodiments disclosed herein with respect to FIGS. 1-2 may be implemented in any integrated circuit or electronic system. If desired, the functional blocks of such an integrated circuit may be arranged in more levels or layers in which multiple functional blocks are interconnected to form still larger blocks. Other device arrangements may use functional blocks that are not arranged in rows and columns.

Programmable logic IC 300 may contain programmable memory elements. Memory elements may be loaded with configuration data using IOEs 302. Once loaded, the memory elements each provide a corresponding static control signal that controls the operation of an associated configurable functional block (e.g., LABs 310, DSP blocks 320, RAM blocks 330, or IOEs 302).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory bits of the row that was designated by the address register.

In certain embodiments, programmable logic IC 300 may include configuration memory that is organized in sectors, whereby a sector may include the configuration RAM bits that specify the functions and/or interconnections of the subcomponents and wires in or crossing that sector. Each sector may include separate data and address registers.

The programmable IC of FIG. 3 is merely one example of an IC that can include embodiments disclosed herein. The embodiments disclosed herein may be incorporated into any suitable integrated circuit or system. For example, the embodiments disclosed herein may be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

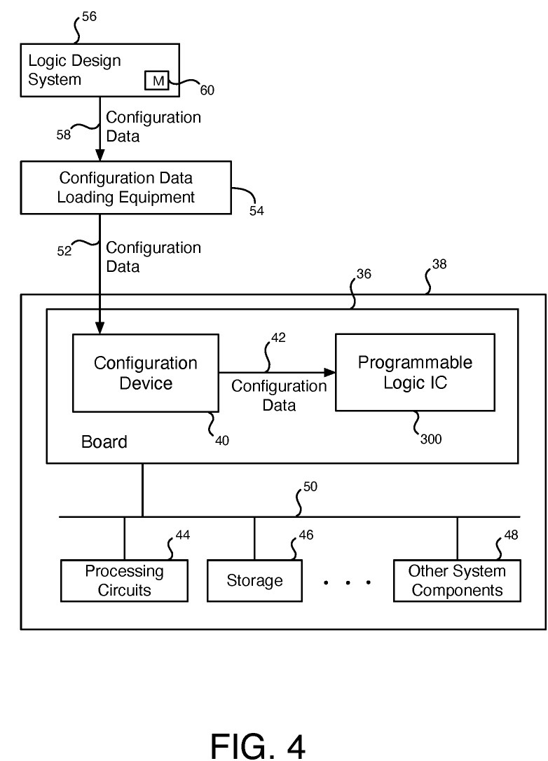

An illustrative system environment for IC 300 is shown in FIG. 4. IC 300 can be mounted on a board 36 in a system 38. In general, programmable logic IC 300 can receive configuration data from programming equipment or from other suitable equipment or device. In the example of FIG. 4, programmable IC 300 is a type of programmable logic device that receives configuration data from an associated configuration device 40. With this type of arrangement, configuration device 40 can, if desired, be mounted on the same board 36 as programmable logic IC 300.

Configuration device 40 can be an erasable-programmable read-only memory (EPROM) chip, a programmable logic device configuration data loading chip with built-in memory, or other suitable device. When system 38 boots up (or at another suitable time), the configuration data for configuring the programmable logic IC 300 can be supplied to the programmable logic IC 300 from device 40, as shown schematically by path 42. The configuration data that is supplied to the programmable logic IC 300 can be stored in the programmable logic IC 300 in its programmable memory elements.

System 38 can include processing circuits 44, storage 46, and other system components 48 that communicate with IC 300. The components of system 38 can be located on one or more boards such as board 36 or other suitable mounting structures or housings and can be interconnected by buses, traces, and other electrical paths 50.

Configuration device 40 can be supplied with the configuration data for IC 300 over a path, such as path 52. Configuration device 40 can, for example, receive the configuration data from configuration data loading equipment 54 or other suitable equipment that stores this data in configuration device 40. Device 40 can be loaded with data before or after installation on board 36.

In the example of FIG. 4, a logic design system 56 generates the configuration data. The configuration data produced by the logic design system 56 can be provided to equipment 54 over a path, such as path 58. The equipment 54 provides the configuration data to device 40, so that device 40 can later provide this configuration data to the programmable logic IC 300 over path 42. Logic design system 56 can be based on one or more computers and one or more software programs. In general, software and data may be stored on any computer-readable storage medium in system 56 and is shown schematically as storage 60 in FIG. 4.

In a typical scenario, logic design system 56 is used by a logic designer to create a circuit design for IC 300. The system 56 produces corresponding configuration data that is provided to configuration device 40. Upon power-up, configuration device 40 and data loading circuitry in programmable logic IC 300 are used to load the configuration data into the memory elements of IC 300. IC 300 can then be used in normal operation of system 38.

After IC 300 is initially loaded with a set of configuration data (e.g., using configuration device 40), IC 300 can be reconfigured by loading a different set of configuration data. Sometimes, it may be desirable to reconfigure only a portion of the memory elements in IC 300 via a process referred to as partial reconfiguration. As memory elements are typically arranged in an array, partial reconfiguration can be performed by writing new data values only into selected portion(s) in the array, while leaving portions of the array other than the selected portion(s) in their original state.

It can be a significant undertaking to design and implement a desired (custom) logic circuit design in a programmable logic integrated circuit (IC). Logic designers therefore generally use logic design systems based on computer-aided-design (CAD) tools to assist them in designing circuits. A logic design system can help a logic designer design and test complex circuits for a system. When a design is complete, the logic design system can be used to generate configuration data for electrically programming the appropriate programmable logic IC.

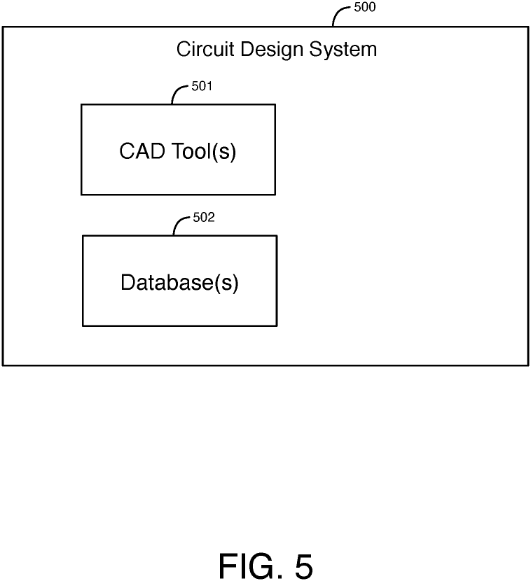

An illustrative circuit design system 500 in accordance with an embodiment is shown in FIG. 5. If desired, the circuit design system of FIG. 5 can be used in a logic design system such as logic design system 56 shown in FIG. 4. Circuit design system 500 can be implemented on integrated circuit design computing equipment. Circuit design system 500 can, for example, include one or more networked computers with processors, memory, mass storage, input/output devices, etc. System 500 can, for example, be based on one or more processors such as personal computers, workstations, etc. The processor(s) can be linked using a network (e.g., a local or wide area network). Memory in these computers or external memory and storage devices can be used to store instructions and data.

Software-based components such as computer-aided design (CAD) tools 501 and databases 502 reside on system 500. During operation, executable software such as the software of computer aided design tools 501 runs on the processor(s) of system 500. Databases 502 are used to store data for the operation of system 500. In general, software and data may be stored in non-transitory computer readable storage media (e.g., tangible computer readable storage media). The software code may sometimes be referred to as software, data, program instructions, instructions, or code. The non-transitory computer readable storage media may include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Software stored on the non-transitory computer readable storage media may be executed on system 500. When the software of system 500 is installed, the storage of system 500 has instructions and data that cause the computing equipment in system 500 to execute various methods (processes). When performing these processes, the computing equipment is configured to implement the functions of circuit design system 500.

The computer aided design (CAD) tools 501, some or all of which are sometimes referred to collectively as a CAD tool, a circuit design tool, or an electronic design automation (EDA) tool, may be provided by a single vendor or by multiple vendors. Tools 501 may be provided as one or more suites of tools (e.g., a compiler suite for performing tasks associated with implementing a circuit design in a programmable IC) and/or as one or more separate software components (tools). Database(s) 502 may include one or more databases that are accessed only by a particular tool or tools and may include one or more shared databases. Shared databases may be accessed by multiple tools. For example, a first tool may store data for a second tool in a shared database. The second tool may access the shared database to retrieve the data stored by the first tool. This allows one tool to pass information to another tool. Tools may also pass information between each other without storing information in a shared database if desired.

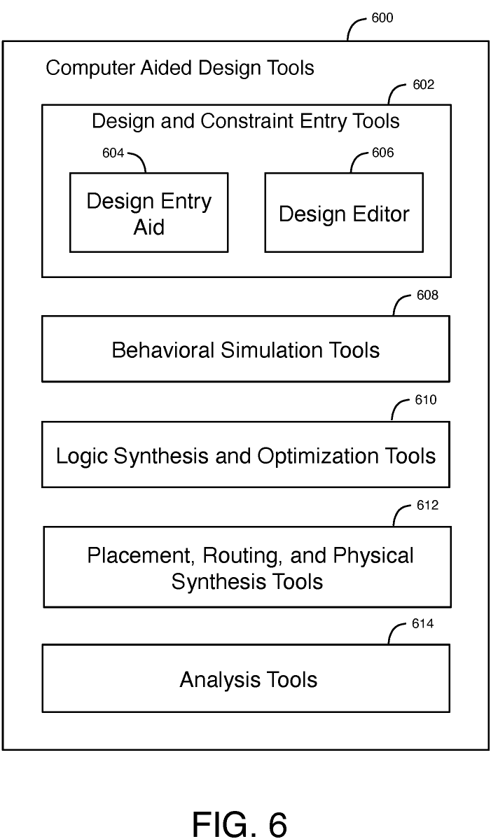

Illustrative computer aided design tools 600 that can be used in a circuit design system such as circuit design system 500 of FIG. 5 are shown in FIG. 6. The design process can start with the formulation of functional specifications of the integrated circuit design (e.g., a functional or behavioral description of the integrated circuit design). A circuit designer can specify the functional operation of a desired circuit design using design and constraint entry tools 602. Design and constraint entry tools 602 can include tools such as design and constraint entry aid 604 and design editor 606. Design and constraint entry aids such as aid 604 can be used to help a circuit designer locate a desired design from a library of existing circuit designs and can provide computer-aided assistance to the circuit designer for entering (specifying) the desired circuit design. Design and constraint entry tools 602 can allow a circuit designer to enter timing constraints for the desired circuit design through aid 604.

As an example, design and constraint entry aid 604 can be used to present screens of options for a user. The user can click on on-screen options to select whether the circuit being designed should have certain features. Design editor 606 can be used to enter a design (e.g., by entering lines of hardware description language code), can be used to edit a design obtained from a library (e.g., using a design and constraint entry aid), or can assist a user in selecting and editing appropriate prepackaged code/designs. The GUI disclosed herein with respect to FIG. 1 can be part of (e.g., generated by) the design entry aid 604.

Design and constraint entry tools 602 can be used to allow a circuit designer to provide a desired circuit design using any suitable format. For example, design and constraint entry tools 602 can include tools that allow the circuit designer to enter a circuit design using truth tables. Truth tables can be specified using text files or timing diagrams and can be imported from a library. Truth table circuit design and constraint entry can be used for a portion of a large circuit or for an entire circuit.

As another example, design and constraint entry tools 602 can include a schematic capture tool. A schematic capture tool can allow the circuit designer to visually construct integrated circuit designs from constituent parts such as logic gates and groups of logic gates. Libraries of preexisting integrated circuit designs can be used to allow a desired portion of a design to be imported with the schematic capture tools.

If desired, design and constraint entry tools 602 can allow the circuit designer to provide a circuit design to the circuit design system 500 using a hardware description language such as Verilog hardware description language (Verilog HDL), Very High Speed Integrated Circuit Hardware Description Language (VHDL), System Verilog, or a higher-level circuit description language such as OpenCL or SystemC, just to name a few. The designer of the integrated circuit design can enter the circuit design by writing hardware description language code with editor 606. Blocks of code can be imported from user-maintained or commercial libraries if desired.

After the circuit design has been entered using design and constraint entry tools 602, behavioral simulation tools 608 can be used to simulate the functionality of the circuit design. If the functionality of the design is incomplete or incorrect, the circuit designer can make changes to the circuit design using design and constraint entry tools 602. The functional operation of the new circuit design can be verified using behavioral simulation tools 608 before synthesis operations have been performed using tools 610. Simulation tools such as behavioral simulation tools 608 can also be used at other stages in the design flow if desired (e.g., after logic synthesis). The output of the behavioral simulation tools 608 can be provided to the circuit designer in any suitable format (e.g., truth tables, timing diagrams, etc.).

After the functional operation of the circuit design has been determined to be satisfactory, logic synthesis and optimization tools 610 can generate a gate-level netlist of the circuit design, for example, using gates from a particular library pertaining to a targeted process supported by a foundry that has been selected to produce the integrated circuit. Alternatively, logic synthesis and optimization tools 610 can generate a gate-level netlist of the circuit design using gates of a targeted programmable IC (i.e., in the logic and interconnect resources of a particular programmable IC product or product family).

Logic synthesis and optimization tools 610 can optimize the circuit design by making appropriate selections of hardware to implement different logic functions in the circuit design based on the circuit design data and constraint data entered by the logic designer using tools 602. As an example, logic synthesis and optimization tools 610 can perform multi-level logic optimization and technology mapping based on the length of a combinational path between registers in the circuit design and corresponding timing constraints that were entered by the logic designer using tools 602.

After logic synthesis and optimization using tools 610, the circuit design system 500 can use tools such as placement, routing, and physical synthesis tools 612 to perform physical design steps (layout synthesis operations). Tools 612 can be used to determine where to place each gate of the gate-level netlist produced by tools 610. For example, if two counters interact with each other, tools 612 may locate these counters in adjacent regions to reduce interconnect delays or to satisfy timing requirements specifying the maximum permitted interconnect delay. Tools 612 create orderly and efficient implementations of circuit designs for any targeted integrated circuit (e.g., for a given programmable integrated circuit such as a field-programmable gate array (FPGA)).

Tools such as tools 610 and 612 can be part of a compiler suite (e.g., part of a suite of compiler tools provided by a programmable IC vendor). After an implementation of the desired circuit design has been generated using tools 612, the implementation of the design can be analyzed and tested using analysis tools 614. For example, analysis tools 614 can include timing analysis tools, power analysis tools, or formal verification tools, just to name few.

After satisfactory optimization operations have been completed using tools 600 and depending on the targeted integrated circuit technology, tools 600 can produce a mask-level layout description of the integrated circuit or configuration data for programming the programmable logic IC.

The following examples pertain to further embodiments. Example 1 is an IC device comprising: an interface to receive a first bitstream from outside of the IC device and to transmit a second bitstream outside of the IC device; a decryption circuit configurable to apply a first decryption algorithm selected from a plurality of decryption algorithms to the first bitstream to decrypt the first bitstream; and an encryption circuit configurable to apply a first encryption algorithm selected from a plurality of encryption algorithms to the second bitstream to encrypt the second bitstream.

In Example 2, the IC device of Example 1 may optionally further comprise a selection circuit configurable to: configure the decryption circuit to apply the first decryption algorithm to decrypt the first bitstream; and/or configure the encryption circuit to apply the first encryption algorithm to encrypt the second bitstream.

In Example 3, the IC device of Example 1 or 2 may optionally further comprise a key wrapping circuit configured to: receive a decryption key associated with the decryption algorithm or an encryption key associated with the encryption algorithm; and apply a key wrapping encryption algorithm to the decryption key or the encryption key to encrypt the decryption key and/or the encryption key using a wrapping encryption key to generate a wrapped decryption key and/or a wrapped encryption key.

In Example 4, the IC device of Example 3 may optionally further comprise an entropy source circuit configurable to generate the wrapping encryption key.

In Example 5, the IC device of Example 3 or 4 may optionally further comprise a firewall circuit configurable to prevent unauthorized access to the wrapped decryption key and/or the wrapped encryption key.

In Example 6, the IC device of any one of Examples 1-5, may optionally include, wherein the IC device comprises a programmable logic device (PLD), field-programmable gate array (FPGA) device, application specific integrated circuit (ASIC) device, random access memory (RAM) device, or graphics processing unit (GPU) device.

In Example 7, the IC device of any one of Examples 2-6 may optionally include, wherein the selection circuit is further configurable to: reconfigure the decryption circuit to apply a second decryption algorithm that is different than the first decryption algorithm to decrypt the first bitstream; and/or reconfigure the encryption circuit to apply a second encryption algorithm that is different than the first encryption algorithm to encrypt the second bitstream.

Example 8 is a method for using an integrated circuit (IC) device, comprising: receiving a first bitstream from outside the integrated circuit device; applying a first decryption algorithm to the first bitstream to decrypt the first bitstream using a decryption circuit that is configurable to select the first decryption algorithm from a plurality of decryption algorithms; transmitting a second bitstream outside of the IC device; and applying a first encryption algorithm to the second bitstream to encrypt the second bitstream using an encryption circuit that is configurable to select the first encryption algorithm from a plurality of encryption algorithms.

In Example 9, the method of claim 8 may optionally further comprise configuring a selection circuit of the IC device to: configure the decryption circuit to apply the first decryption algorithm to decrypt the first bitstream; and/or configure the encryption circuit to apply the first encryption algorithm to encrypt the second bitstream.

In Example 10, the method of Example 8 or 9 may optionally further comprise: receiving a decryption key associated with the decryption algorithm and/or an encryption key associated with the encryption algorithm; and applying a key wrapping encryption algorithm to the decryption key and/or the encryption key to encrypt the decryption key and/or the encryption key using a wrapping encryption key and generate a wrapped decryption key and/or a wrapped encryption key.

In Example 11, the method of Example 10 may optionally further comprise generating the wrapping encryption key using an entropy source circuit.

In Example 12, the method of Example 10 or 11 may optionally further comprise preventing unauthorized access to the wrapped decryption key and/or the wrapped encryption key using a firewall circuit.

In Example 13, the method of any one of Examples 8-12 may optionally include, wherein the IC device comprises a PLD, FPGA device, ASIC device, RAM device, or GPU device.

In Example 14, the method of any one of Examples 9-13 may optionally include configuring the selection circuit to: reconfigure the decryption circuit to apply a second algorithm that is different from the first decryption algorithm to decrypt the first bitstream; and/or reconfigure the encryption circuit to apply a second encryption algorithm that is different from the first encryption algorithm to encrypt the second bitstream.

Example 15 is a non-transitory computer-readable storage medium comprising instructions stored thereon for causing an integrated circuit device to execute a method for configuring the integrated circuit device, the method comprising: configuring a decryption circuit of the integrated circuit device to apply a first decryption algorithm selected from a plurality of decryption algorithms to a first bitstream to decrypt the first bitstream; and configuring an encryption circuit of the integrated circuit device to apply a first encryption algorithm selected from a plurality of encryption algorithms to a second bitstream to encrypt the second bitstream.

In Example 16, the non-transitory computer-readable storage medium of Example 15 may optionally further include, wherein the method further comprises configuring a selection circuit of the IC device to: configure the decryption circuit to apply the first decryption algorithm to decrypt the first bitstream; and/or configure the encryption circuit to apply the first encryption algorithm to encrypt the second bitstream.

In Example 17, the non-transitory computer-readable storage medium of Example 15 or 16, may optionally further include wherein the method further comprises configuring a key wrapping circuit of the IC device to: receive a decryption key associated with the decryption algorithm and/or an encryption key associated with the encryption algorithm; and apply a key wrapping encryption algorithm to the decryption key and/or the encryption key to thereby encrypt the decryption key and/or the encryption key using a wrapping encryption key and generate a wrapped decryption key and/or a wrapped encryption key.

In Example 18, the non-transitory computer-readable storage medium of Example 17 may optionally further include, wherein the method further comprises configuring an entropy source circuit of the IC device to generate the wrapping encryption key.

In Example 19, the non-transitory computer-readable storage medium of Example 17 or 18 may optionally further include, wherein the method further comprises configuring a firewall circuit of the IC device to prevent unauthorized access to the wrapped decryption key and/or the wrapped encryption key.

In Example 20, the non-transitory computer-readable storage medium of any one of Examples 15-19 may optionally further include, wherein the IC device comprises a PLD, FPGA device, ASIC device, RAM device, or GPU device.

In Example 21, the non-transitory computer-readable storage medium of any one of Examples 16-20 may optionally further include, wherein the method further comprises configuring the selection circuit to: reconfigure the decryption circuit to apply a second decryption algorithm that is different than the first decryption algorithm to decrypt the first bitstream; and/or reconfigure the encryption circuit to apply a second encryption algorithm that is different than the first encryption algorithm to encrypt the second bitstream.

According to additional examples, any of the Examples 1-21 disclosed above can be implemented by a system, an IC, or as a method, including as a method implemented by code stored on a non-transitory computer readable storage medium.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit (IC) device comprising:
an interface to receive a first bitstream from outside of the IC device and to transmit a second bitstream outside of the IC device;
a decryption circuit configurable to apply a first decryption algorithm selected from a plurality of decryption algorithms to the first bitstream to decrypt the first bitstream; and
an encryption circuit configurable to apply a first encryption algorithm selected from a plurality of encryption algorithms to the second bitstream to encrypt the second bitstream.

2. The IC device of claim 1, further comprising a selection circuit configurable to:
configure the decryption circuit to apply the first decryption algorithm to decrypt the first bitstream; or
configure the encryption circuit to apply the first encryption algorithm to encrypt the second bitstream.

3. The IC device of claim 1, further comprising a key wrapping circuit configured to:
receive a decryption key associated with the first decryption algorithm or an encryption key associated with the first encryption algorithm; and
apply a key wrapping encryption algorithm to the decryption key or the encryption key to encrypt the decryption key or the encryption key using a wrapping encryption key to generate a wrapped decryption key and/or a wrapped encryption key.

4. The IC device of claim 3, further comprising an entropy source circuit configurable to generate the wrapping encryption key.

5. The IC device of claim 3, further comprising a firewall circuit configurable to prevent unauthorized access to the wrapped decryption key or the wrapped encryption key.

6. The IC device of claim 1, wherein the IC device comprises a programmable logic device (PLD), field-programmable gate array (FPGA) device, application specific integrated circuit (ASIC) device, random access memory (RAM) device, or graphics processing unit (GPU) device.

7. The IC device of claim 2, wherein the selection circuit is further configurable to:
reconfigure the decryption circuit to apply a second decryption algorithm that is different than the first decryption algorithm to decrypt the first bitstream; or
reconfigure the encryption circuit to apply a second encryption algorithm that is different than the first encryption algorithm to encrypt the second bitstream.

8. A method for using an integrated circuit device, comprising:
receiving a first bitstream from outside the integrated circuit device;
applying a first decryption algorithm to the first bitstream to decrypt the first bitstream using a decryption circuit that is configurable to select the first decryption algorithm from a plurality of decryption algorithms;
transmitting a second bitstream outside of the IC device; and
applying a first encryption algorithm to the second bitstream to encrypt the second bitstream using an encryption circuit that is configurable to select the first encryption algorithm from a plurality of encryption algorithms.

9. The method of claim 8, further comprising configuring a selection circuit of the integrated circuit device to:
configure the decryption circuit to apply the first decryption algorithm to decrypt the first bitstream; or
configure the encryption circuit to apply the first encryption algorithm to encrypt the second bitstream.

10. The method of claim 8, further comprising:
receiving a decryption key associated with the first decryption algorithm or an encryption key associated with the first encryption algorithm; and
applying a key wrapping encryption algorithm to the decryption key or the encryption key to encrypt the decryption key or the encryption key using a wrapping encryption key and generate a wrapped decryption key or a wrapped encryption key.

11. The method of claim 10, further comprising generating the wrapping encryption key using an entropy source circuit.

12. The method of claim 10, further comprising preventing unauthorized access to the wrapped decryption key or the wrapped encryption key using a firewall circuit.

13. The method of claim 8, wherein the integrated circuit device comprises a programmable logic device (PLD), field-programmable gate array (FPGA) device, application specific integrated circuit (ASIC) device, random access memory (RAM) device, or graphics processing unit (GPU) device.

14. The method of claim 9, further comprising configuring the selection circuit to:
reconfigure the decryption circuit to apply a second decryption algorithm that is different from the first decryption algorithm to decrypt the first bitstream; or
reconfigure the encryption circuit to apply a second encryption algorithm that is different from the first encryption algorithm to encrypt the second bitstream.

15. A non-transitory computer-readable storage medium comprising instructions stored thereon for causing an integrated circuit device to execute a method for configuring the integrated circuit device, the method comprising:
configuring a decryption circuit of the integrated circuit device to apply a first decryption algorithm selected from a plurality of decryption algorithms to a first bitstream to decrypt the first bitstream; and
configuring an encryption circuit of the integrated circuit device to apply a first encryption algorithm selected from a plurality of encryption algorithms to a second bitstream to encrypt the second bitstream.

16. The non-transitory computer-readable storage medium of claim 15, wherein the method further comprises configuring a selection circuit of the integrated circuit device to:
configure the decryption circuit to apply the first decryption algorithm to decrypt the first bitstream; or
configure the encryption circuit to apply the first encryption algorithm to encrypt the second bitstream.

17. The non-transitory computer-readable storage medium of claim 15, wherein the method further comprises configuring a key wrapping circuit of the integrated circuit device to:
receive a decryption key associated with the first decryption algorithm or an encryption key associated with the first encryption algorithm; and
apply a key wrapping encryption algorithm to the decryption key or the encryption key to encrypt the decryption key or the encryption key using a wrapping encryption key and generate a wrapped decryption key or a wrapped encryption key.

18. The non-transitory computer-readable storage medium of claim 17, wherein the method further comprises configuring an entropy source circuit of the integrated circuit device to generate the wrapping encryption key.

19. The non-transitory computer-readable storage medium of claim 17, wherein the method further comprises configuring a firewall circuit of the integrated circuit device to prevent unauthorized access to the wrapped decryption key or the wrapped encryption key.

20. The non-transitory computer-readable storage medium of claim 15, wherein the integrated circuit device comprises a programmable logic device (PLD), field-programmable gate array (FPGA) device, application specific integrated circuit (ASIC) device, random access memory (RAM) device, or graphics processing unit (GPU) device.

21. The non-transitory computer-readable storage medium of claim 16, wherein the method further comprises configuring the selection circuit to:
reconfigure the decryption circuit to apply a second decryption algorithm that is different than the first decryption algorithm to decrypt the first bitstream; or
reconfigure the encryption circuit to apply a second encryption algorithm that is different than the first encryption algorithm to encrypt the second bitstream.
